(19) United States
(12) Patent Application Publication
(10) Pub. No.: US 2008/0257143 A1
(43) Pub. Date: Oct. 23, 2008

(54) METHODS AND APPARATUS FOR A FLUID OR SLURRY PUMP PISTON

(76) Inventor: William W. Leman, Navasota, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/955,593

(22) Filed: Dec. 13, 2007

Related U.S. Application Data
(60) Provisional application No. 60/923,878, filed on Apr. 17, 2007.

(51) Int. Cl. F01B 25/26; F16J 1/00

(52) U.S. Cl. 92/5 R; 92/255

(57) ABSTRACT

A method and apparatus for a reciprocating pump, specifically, a single acting fluid or slurry pump piston. The piston assembly includes a reserve seal that is operable and adapted to maintain a pump operation in the event of a primary piston seal failure. The reserve seal allows the communication of the primary piston seal failure to a pump operator or worker so that they may take timely remedial measures, thereby avoiding the numerous consequences of a complete piston failure. The piston assembly includes an indicator that is adapted to communicate to the pump operator or worker that the primary piston seal has failed.

### CROSS-REFERENCE TO RELATED APPLICATIONS

This application claims benefit of U.S. provisional patent application Ser. No. 60/923,878, filed Apr. 17, 2007, which is herein incorporated by reference in its entirety.

### BACKGROUND OF THE INVENTION

1. Field of the Invention

Embodiments of the present invention generally relate to a pump piston.

2. Description of the Related Art

This invention relates to improvements of reciprocating fluid or slurry pumps. Specifically, the present invention relates to an improved single acting pump piston. Single acting piston pumps can be employed in a variety of drilling applications, such as oil and gas drilling, horizontal drilling, offshore drilling, and water well drilling. Although the invention will be described with particular reference to fluid or slurry pumps, such as a mud pump, it will be recognized that certain features may be used or adopted for use in other types of pumps and pumping applications.

Mud pumps are used in the oil and gas drilling industry for circulating drilling fluids. They are positive displacement pumps that include pistons mounted on reciprocating rods within cylindrical sleeves or liners. These pumps typically operate at high pressures due to the necessity for pumping the drilling fluid through numerous extensive sections of pipe. The pistons and liners are subjected to a high degree of wear during use because the drilling fluid may contain abrasive and corrosive materials. In addition, due to the contact force of the piston on the liner wall, problems related to frictional heat build up may exacerbate potential piston seal failures. A piston seal failure can disrupt a drilling operation that has thousands of feet of pipe in a well bore, resulting in a tremendous amount of monetary expense and time loss. U.S. Pat. Nos. 7,168,361 and 6,164,188 provide examples of reciprocating pumps, each of which are herein incorporated by reference in their entirety.

FIG. 1 shows a conventional piston assembly 10. The piston assembly includes a piston hub 11, a piston rod 12, a piston rod nut 13, and a piston seal 15. Generally, the piston assembly 10 is disposed within a liner (not shown). The piston hub 11 has a through bore at its center, which is adapted to receive a lower end of the piston rod 12. The opposite end of the piston rod 12 has a radially flanged shoulder that abuts the top of the piston hub 11 and prevents it from being completely received through the through bore. The piston seal 15 may be fitted over the lower end of the hub and against the upper end of the hub, exposing the lower end of the piston rod 12 through its center. The piston rod nut 13 is threaded onto the lower end of the piston rod 12, pressing the rod and the piston hub 11 together. Since the diameter of the piston seal 15 extends beyond the piston hub diameter, the piston assembly 10 may form a sealed engagement within the liner. However, if the primary piston seal fails, the pumping operation may be shutdown. In a reciprocating pump, a volume of liquid is drawn into the pump chamber through a suction valve on the intake stroke and is discharged under positive pressure through an outlet valve on the discharge stroke.

Generally, a pump piston failure is caused by excessive clearance between the piston seal and the liner wall. As the liner and/or the seal wear and erode, the annular clearance between the piston and the liner wall will enlarge considerably. As this occurs, there may be a continuous high velocity of fluid slippage between the piston and the liner. This constant jetting fluid may cause irreversible “wash cuts” that damage the piston and the liner, preventing a piston seal and necessitating a liner and/or piston replacement. Streaking of the liner and the piston seal may also be caused by aggregate or other abrasive materials in the fluid or slurry. With the escalating clearance between the piston and the liner, the efficiency and the service life of the pump rapidly diminishes.

In addition, during a drilling or pumping operation, it may be necessary to use two or more pumps in a series. The failure of one pump piston seal may thus disrupt the entire pumping operation, resulting in costly expenses. Other drilling or pumping operations may require a consistently maintained pressure throughout the operation, and a piston seal failure or breach can result in a loss of pressure, similarly resulting in a costly operation stoppage.

Finally, when a piston failure occurs and the piston seal rapidly deteriorates, there are many other consequences that may arise. For example, when a pump piston seal fails it could release a fluid at an extremely high pressure. This dangerous fluid pressure can potentially injure a worker or any other nearby person, as well as cause damage to other surrounding equipment. Depending on the type of fluid in the pump or the location of the pump, numerous environmental harms and clean up costs can be associated with a seal failure. In another example, some mud pumps are fitted with a cooling system that circulates water on the back side of the piston, the piston rod, and the “pony” rod, which is connected to the gear end that drives the piston. Once the piston seal is breached, the drilling mud may contaminate the cooling system and may be sprayed onto these components, allowing the mud to seep into the gear end and damage its gears, bearings, and other internal seals. Lastly, because the piston, piston seal, and liner all wear at different rates and have different useful operating lives, a seal failure can prematurely ruin any or all of the other components.

Based on the above discussed scenarios, the seal design for such pump pistons is critical. Standard pump pistons used today only have one sealing element with respect to the liner. When the seal is breached, the pumping application is exposed to all of the consequences of that failure. Due to the infinite number of pumping conditions and factors that can contribute to a piston seal failure, it is extremely difficult to predict such an event. It is almost impossible to sustain an efficient preventive maintenance plan to prevent a piston failure. Therefore, the premature replacement of standard piston components, prior to their useful life, results in a continual high cost of operation for these types of pumps. In addition, simply allowing a pump piston to fully operate until it fails may result in costly repairs and other dangerous outcomes. Such a reactive approach is not always successful because the operator is unknowing of the failure condition until it is too late. For example, the pump operator may not notice the mud/fluid discharge because of the muddy operating environment surrounding the pump that includes other fluids, oils, or washes necessary to conduct a drilling or pumping application.

Therefore, there is a need for a pump piston that can help prevent or avoid the damaging outcomes of a seal failure, while maximizing the useful life of the piston and other operating components. There is also a need for a pump piston that can protect human personnel from harm and protect the environment from exposure to dangerous, corrosive, or toxic fluids due to a seal failure. There is an even further need for a pump piston that can identify and indicate a seal failure, thereby allowing a proactive, rather than a reactive, approach to piston maintenance and failure.

### SUMMARY OF THE INVENTION

The present invention generally relates to a reciprocating fluid or slurry pump piston assembly. In one embodiment, the piston assembly includes a piston, a primary seal, and a secondary seal, wherein the secondary seal is operable and adapted to maintain a pump operation in the event of a primary seal failure. The piston assembly includes an indicator that is adapted to communicate to a pump operator or worker that the primary seal has failed.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a sectional view of a conventional piston assembly.

FIG. 2 is a sectional view of one embodiment of the piston assembly.

FIG. 2B is a top view of one embodiment of the piston assembly.

FIG. 3A is a sectional view of one embodiment of an indicator housing.

FIG. 3B is a sectional view of one embodiment of an indicator plug.

FIG. 3C is a sectional view of one embodiment of an indicator pin.

FIG. 3D is a sectional view of one embodiment of an indicator seal pin.

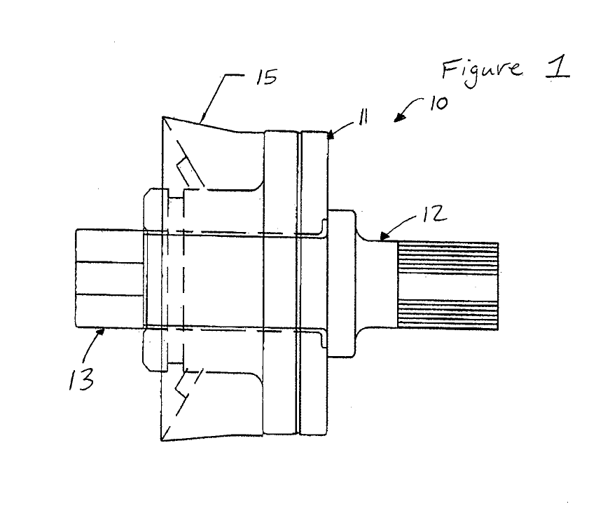

### DETAILED DESCRIPTION

The present invention generally relates to an apparatus and method of a fluid or slurry pump piston. As set forth herein, the invention will be described as it relates to a single acting, reciprocating mud pumping operation. It is to be noted, however, that aspects of the present invention are not limited to such an operation, but are equally applicable to other types of pumps and pumping applications. To better understand the novelty of the apparatus of the present invention and the methods of use thereof, reference is hereafter made to the accompanying drawings.

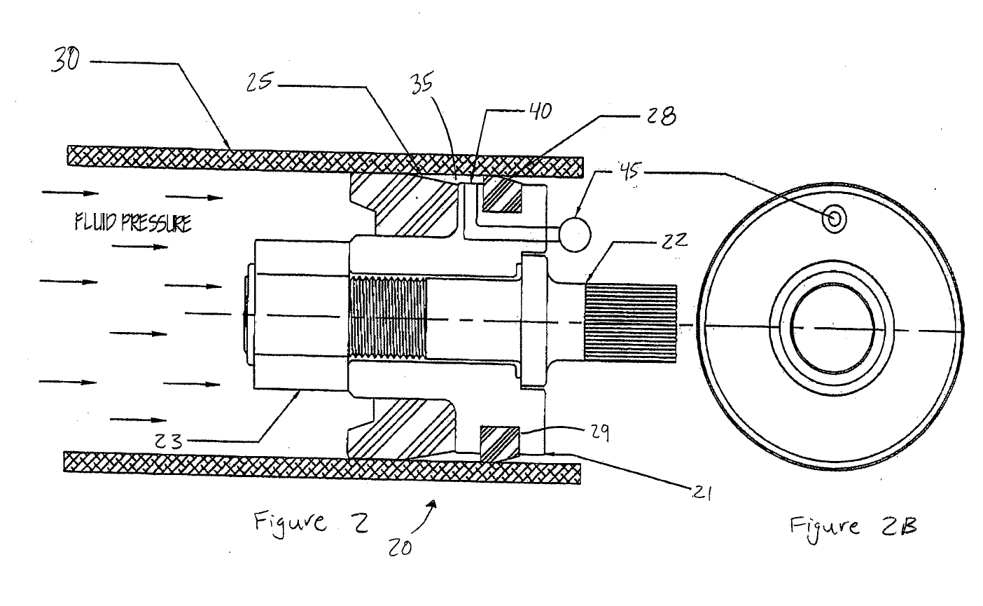

FIG. 2 shows one embodiment of the present piston assembly 20 invention. The piston assembly 20 is disposed within a liner 30. The liner 30 may be generally described as a cylindrical sleeve or housing in which the piston assembly 20 reciprocates. The piston assembly 20 seals against the liner 30 to maintain fluid operation within the internal chamber of the liner. The piston assembly 20 includes a piston hub 21, a piston rod 22, a piston rod nut 23, and a primary piston seal 25. Also, one side of the piston assembly 20 is exposed to a fluid pressure, while the opposite side may be viewable to a person, such as a worker or operator, depending on the location of the actual pump.

The primary piston seal 25 is attached around the bottom portion of the piston hub 21 and is adapted to sealingly and slideably engage with the liner 30. The piston rod 22 is partially threaded with and extends through the center of the piston hub 21. The piston rod 22 has a flanged section that abuts a shoulder of the piston hub 21 at one end. At the opposite end, the piston rod nut 23 threads onto the piston rod 22 to tighten the rod and the hub together.

The primary piston seal 25 is seated against a flanged end of the piston hub 21 on one side. On the other side, the primary piston seal 25 includes a lip that is adapted to receive the fluid pressure. As the primary piston seal 25 receives the fluid pressure, a force is applied to the inner diagonal of the lip of the primary piston seal 25, pressing the seal against the liner 30 to form a sealed engagement and maintain the fluid pressure inside the liner. In addition, the outer diameter of the primary piston seal 25 includes an outwardly directed periphery that forms the outer surface of the lip and that partially engages with the liner 30.

The primary piston seal 25 may be attached to the piston hub 21 or held in position in a variety of ways. In an optional embodiment, the primary piston seal 25 is removably attached to the piston hub 21. In an alternative embodiment, the primary piston seal 25 is bonded to the piston hub 21. In an alternative embodiment, the primary piston seal 25 is press fit to the piston hub 21. In an alternative embodiment, the primary piston seal 25 is attached to the piston hub 21 and/or held in position with a snap ring. In an alternative embodiment, the primary piston seal 25 is mechanically fitted to the piston hub 21. It is important to note that the primary piston seal 25 may be attached to the piston hub 21 and/or held in position in a variety of other ways known by one of ordinary skill in the art.

The piston assembly 20 further includes a secondary piston seal 28, a channel 40, and an indicator 45. In addition, the piston assembly 20 forms a chamber 35 with the liner 30. Specifically, the chamber 35 is located between the primary piston seal 25 and the secondary piston seal 28 and is further fashioned by the liner wall 30 and the piston hub 21. During operation, the primary piston seal 25 and the secondary piston seal 28 are adapted to sealingly and slideably engage with the liner 30.

The secondary piston seal 28 is operable upon a failure or breach of the primary piston seal 25. The secondary piston seal 28 permits the communication of the primary piston seal 25 failure or breach to a pump operator or worker. By permitting this communication, the secondary piston seal 28 allows the pump operator or worker to take notice of the primary piston seal 25 failure and take timely remedial measures, prior to a complete pump piston failure. The secondary piston seal 28 serves as a back up or reserve seal to maintain pump pressure and operation in the event that the primary piston seal 25 fails or is breached.

The secondary piston seal 28 is seated in a recess 29 on the periphery of the upper portion of the piston hub 21. The outer perimeter of the secondary piston seal 28 is larger than the outer diameter of the upper portion of the piston hub 21 and extends beyond the recess 29 to engage with the liner 30. The outer perimeter of the secondary piston seal 28 includes an outwardly directed periphery that partially engages with the liner 30. A portion, or all, of the outer perimeter of the secondary piston seal 28 may engage and/or seal with the liner 30. As the piston assembly 20 reciprocates, the secondary piston seal 28 slideably engages the liner 30 and is held in position by the recess 29. As the secondary piston seal receives the fluid pressure, the outer perimeter is forced in an outward direction to form a sealed engagement and maintain the fluid pressure in the liner 30. The secondary piston seal 28 sealingly engages with the liner 30 upon activation by the fluid pressure.

The secondary piston seal 28 allows a window of opportunity for a pump operator or worker to recognize when the primary piston seal 25 has failed or has been breached. The secondary piston seal 28 maintains the pump operation while the primary piston seal 25 failure is communicated and while the pump operators or workers prepare to repair the piston. By allowing these timely corrective measures, the secondary piston seal 28 in effect helps prevent the numerous consequences of a complete piston failure. Several examples will be discussed herein.

For example, if the primary piston seal 25 fails, a continuous jet of fluid, which may contain abrasive particles, may surge out between the piston hub 21 and the liner 30 and create irreversible wash cuts in the liner. The secondary piston seal 28 will help prevent this continuous surge and help indicate to the pump operator or worker that the primary piston seal 25 has been breached. The operator or worker may then take action to replace the primary piston seal 25, thereby maximizing the useful life of the piston hub 21, the primary piston seal 25, and the liner 30. In another example, it may be necessary to use two or more pumps in a series during a pumping operation. The failure of one primary piston seal 25 may thus disrupt the entire pumping operation, resulting in costly expenses. However, the secondary piston seal 25 will maintain the operation and allow the pump operator or worker to recognize the primary piston seal 25 failure and remedy the situation prior to any total disruption. In a further example, the pumping operation may require a consistently maintained pressure throughout the entire operation. A primary piston seal 25 failure or breach can result in a loss of pressure, resulting in a costly operation stoppage. Again, the secondary piston seal 28 will maintain the pressure and allow the pump operator or worker to recognize and timely address the primary piston seal 25 failure before a complete piston failure occurs. In a final example, if the primary piston seal 25 fails or is breached, it could release a fluid at an extremely high pressure. This dangerous fluid pressure can potentially injure a worker or any other nearby person, as well as cause damage to other surrounding equipment. Depending on the type of fluid, numerous environmental harms and clean up costs can be associated with this seal failure. In addition, the fluid may contaminate the pump's cooling system and get applied to the back side of the piston, as well as the gear end of the pump, allowing the fluid and any fluid particles, solids, or other materials to creep into the gear end and potentially damage its internal components. The secondary piston seal 28 will prevent this fluid escape and allow the pump operator or worker to take notice of and appropriately address the primary piston seal 25 failure before a complete piston failure occurs.

The secondary piston seal 28 may be attached to the piston hub 21 and/or held in position in a variety of ways. In an optional embodiment, the secondary piston seal 28 is removably attached to the piston hub 21. In an alternative embodiment, the secondary piston seal 28 is bonded to the piston hub 21. In an alternative embodiment, the secondary piston seal 28 is press fit to the piston hub 21. In an alternative embodiment, the secondary piston seal 28 is attached to the piston hub 21 or held in position with a snap ring. In an alternative embodiment, the secondary piston seal 28 is mechanically fitted to the piston hub 21. It is important to note that the secondary piston seal 28 may be attached to the piston hub 21 and/or held in position in a variety of other ways known by one of ordinary skill in the art.

The primary piston seal 25 and the secondary piston seal 28 may be formed from a polymer such as an elastomer, including rubber and polyurethane, or any other types of similar elastomer or polymer. In addition, the primary piston seal 25 and the secondary piston seal 28 may be formed from any other types of compounds that may be used as a sealing component. It is important to note that the primary piston seal 25 and the secondary piston seal 28 may be formed from any other similar sealing materials known by one of ordinary skill in the art.

In an alternative embodiment, a third piston seal (not shown) may be similarly attached to the piston hub 21 as a back up seal to both the primary piston seal 25 and the secondary piston seal 28.

In the event that the primary piston seal 25 fails or is breached, the secondary piston seal 28 becomes operable. The fluid pressure will enter into the chamber 35 and activate the secondary piston seal 28. The secondary piston seal 28 acts as a second line of defense against a failure or breach of the primary piston seal 25 to prevent a shutdown of the pumping operation. The secondary piston seal 28 will also prevent the fluid from contaminating or damaging any other equipment external to the piston, such as a cooling system or a gear end that drives the piston. More importantly, the secondary piston seal 28 will prevent the escaping high pressure fluid from potentially harming any nearby human personnel and causing any environmental catastrophes.

In addition to the secondary piston seal 28, the piston assembly 20 includes the chamber 35, the channel 40, and the indicator 45. The channel 40 acts as a fluid path that is disposed within the piston hub 21 and is adapted to communicate with the chamber 35 and the indicator 45. The indicator 45 is positioned on the piston hub 21 so that it is viewable to the pump operators or workers, which is also shown in FIG. 2B. One or more indicators, including different types or combinations of indicators, may be used with the piston assembly 20.

As the fluid pressure builds up in the chamber 35, it will also enter into the channel 40 and be received by the indicator 45. When this occurs, the fluid pressure will activate the indicator 45. In response, the indicator 45 will transmit a signal or some failure acknowledgment. This signal or acknowledgment can be readily identified and received by the pump operators or workers, to indicate that the primary piston seal 25 has failed or has been breached and that the secondary piston seal 28 has been activated.

The indicator 45 may further be adapted to communicate with a computer monitoring system (not shown), so that the computer monitoring system can monitor and receive any signal or failure acknowledgement of the indicator 45. The computer monitoring system may be situated in a remote location from the actual pump. Once the pump operators or workers are aware of the primary piston seal 25 failure or breach, they may prepare to replace or repair the piston assembly 20 at a convenient time during the pumping operation. This piston assembly 20 will allow the pumping operation to continue until an appropriate point during the operation can be used to take any necessary remedial actions. In addition, the piston assembly 20 will allow the pump operators or workers to maximize the useful life of the piston hub 21, the piston seals 25 and 28, and the liner 30 by not having to constantly replace such components in fear of a piston failure or in response to a failure by only one of the components.

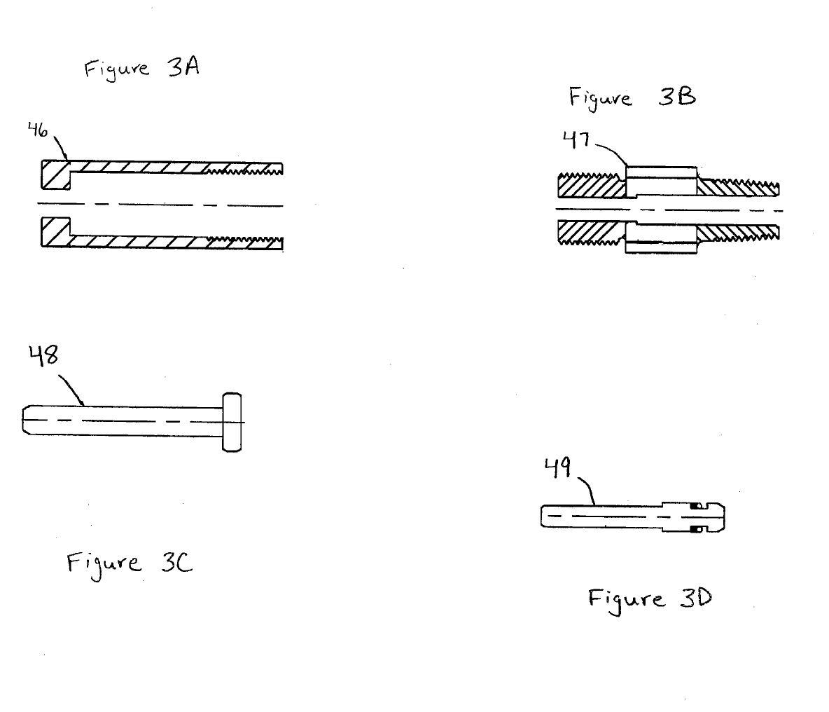

FIGS. 3A-D show the components of one embodiment of the indicator 45, which comprises a housing 46, a plug 47, a first pin 48, and a seal pin 49, and a spring (not shown). The first pin 48 is disposed within the housing 46 with the spring. The housing 46 is threadedly connected to the plug 47 at one end, and at the other end, the plug 47 is adapted to threadedly connect to the piston hub 21 and communicate with the channel 40. The seal pin 49 is sealingly disposed in the plug 47 and is adapted to receive pressure from the channel 40. In the event that the seal pin 49 receives pressure, it is adapted to expose the first pin 48 by forcing it through an opening in the housing 46. The exposed first pin 48 is an indication that the primary piston seal 25 of the piston assembly 20 has been breached or failed.

In an alternative embodiment, the indicator 45 is a pressure sensor. For example, a pressure switch that, when it opens due to pressure, will complete a circuit and will actuate an alarm that provides a visual, auditory, or other type of sensory indication or acknowledgement. In an alternative embodiment, the indicator 45 is adapted to project a visible flag-type indication when it is activated. In an alternative embodiment, the indicator 45 transmits a mechanical signal or failure acknowledgement when it is activated. For example, an indicator that pops out on the back side of the piston. In an alternative embodiment, the indicator 45 may comprise of a visual window or display, by which a pump operator or worker can visibly see fluid in the chamber 35, the channel 40, and/or the piston hub 21, indicating that the primary seal has been breached. In an alternative embodiment, the indicator 45 transmits an electrical signal or failure acknowledgement when it is activated. In an alternative embodiment, the indicator 45 is a sensor that transmits a signal to the computer monitoring system, alerting the pump operators or workers that the primary piston seal has failed or has been breached and that the secondary piston seal has been activated. For example, a transducer that is affixed to the back side of the piston, which is in communication by wire or wirelessly to a computer or similar type of control that displays the electronic signal from the transducer and converts the signal into a pressure reading. For a wireless communication, the piston assembly 20 may also include a battery and transmitter to communicate with the computer monitoring system. It is important to note that one or more of the same, similar, or different types or combinations of indicators may be adapted for use with the piston assembly 20. It is also important to note that the indicator 45 may be adapted to transmit a signal or failure acknowledgement in a variety of ways known by one with ordinary skill in the art.

The piston seal assembly 20 may include a cooling/lubricating system (not shown) due to the chamber 35 formed between the primary piston seal 25 and the secondary piston seal 28. As the piston assembly 20 reciprocates within the liner 30, a large amount of frictional heat may generate between the piston and the liner contact surfaces, particularly with the piston seals. This frictional heat may reduce the useful life of the piston, piston seals, and liner. A cooling/lubricating system may be used to circulate a fluid, such as water or oil, to the area between the primary piston seal 25 and the secondary piston seal 28 to dissipate any frictional heat generation and lubricate the affected area. The chamber 35, with the aid of the two seals, will encapsulate the lubricating fluid between the affected area to continuously disperse the frictional heat and lubricate the contact surfaces. This encapsulating feature will also minimize the amount of lubricating fluid necessary to reduce the friction and lubricate the area and minimize the amount of lubricating fluid waste. Further, the cooling/lubricating system may be adapted to stop circulating fluid once the primary piston seal 25 has failed or is breached. It is important to note that the cooling/lubricating system may be adapted to circulate the fluid to the area between the primary and secondary piston seals in a variety of ways known by one with ordinary skill in the art.

In an alternative embodiment, the piston assembly 20 may be adapted for use in a plunger style pumping application. The piston assembly 20, specifically the reserve seal and the indication mechanism, may be employed in relation to a primary packer disposed around a plunger piston to indicate a breach or failure of the primary packer. The reserve seal may be a reserve or secondary packer with respect to the primary packer. The indication mechanism may be positioned between the primary packer and the secondary packer to indicate a failure or breach of the primary packer. The indication mechanism may be the same as described above with respect to the indicator 45. This indication can be communicated to a pump operator or worker via a computer monitoring system.

While the foregoing is directed to embodiments of the present invention, other and further embodiments of the invention may be devised without departing from the basic scope thereof, and the scope thereof is determined by the claims that follow.

1. A piston assembly for use in a pumping operation comprising:
a piston disposed in a liner; and
a primary seal and a secondary seal, each disposed around the piston for sealing an annular area between the piston and the liner, whereby the secondary seal is operable in the event of a failure of the primary seal.

2. The assembly of claim 1, wherein the primary seal is attached to a first portion of the piston and the secondary seal is attached to a second portion of the piston.

3. The assembly of claim 2, further comprising a chamber formed in the annular area and located between the primary seal and the secondary seal.

4. The assembly of claim 3, whereby when the primary seal fails, fluid pressure enters the chamber and the secondary seal becomes operable.

5. The assembly of claim 4, further including a fluid path formed in a piston hub and terminating at a first end at the chamber.

6. The assembly of claim 5, wherein the fluid path includes a second end terminating at a location external the piston hub.

7. The assembly of claim 6, wherein the fluid pressure provides an indication of failure of the primary seal.

8. The assembly of claim 7, wherein the indication is performed by a mechanical device.

9. The assembly of claim 7, wherein the indication is performed by a visual device.

10. The assembly of claim 7, wherein the indication is performed by an electronic device.

11. The assembly of claim 3, further comprising a cooling/lubricating system adapted to dissipate heat and lubricate the chamber.

12. The assembly of claim 1, further comprising a third seal that is adapted to maintain the pumping operation upon a failure of the secondary seal.

13. A piston assembly for indicating a piston failure comprising:
a piston disposed in a liner of a pump;
a primary seal and a secondary seal, each disposed around the piston and forming a chamber therebetween, wherein the secondary seal is adapted to maintain fluid pressure in the chamber upon failure of the primary seal; and
an indicator that is in communication with the chamber and is adapted to generate a signal upon maintenance of fluid pressure by the secondary seal.

14. The piston assembly of claim 13, wherein the pump comprises a mud pump.

15. The piston assembly of claim 13, wherein the signal is viewable by a pump worker.

16. The piston assembly of claim 13, wherein the signal comprises at least one of a mechanical signal and an electrical signal.

17. The piston assembly of claim 13, further comprising a computer monitoring system that is adapted to receive the signal generated by the indicator.

18. A method for preventing a piston assembly failure comprising:
operating the piston assembly under a working pressure that includes a primary seal and a secondary seal; breaching the primary seal, thereby permitting pressurized fluid to enter a chamber formed between the primary seal and secondary seal;
activating the secondary seal with the pressurized fluid;
maintaining the working pressure with the secondary seal; and
utilizing the pressurized fluid in the chamber to generate a signal indicating a failure of the primary seal.

19. The method of claim 18, whereby the pressurized fluid is received in a fluid path leading from the chamber to provide the signal.

20. The method of claim 18, further comprising communicating the signal to a pump operator or worker.

21. The method of claim 18, further comprising monitoring the piston assembly for the signal indicating the failure of the primary seal with a computer monitoring system.
